(19) United States
(12) Patent Application Publication
(10) Pub. No.: US 2025/0198453 A1
(43) Pub. Date: Jun. 19, 2025

(54) TAPERED ROLLER BEARING

(71) Applicant: NTN CORPORATION, OSAKA (JP)

(72) Inventors: Masaya MASUDA, Kuwana (JP); Taisuke IKIO, Kuwana (JP); Shouta TOHO, Kuwana (JP)

(73) Assignee: NTN CORPORATION, OSAKA (JP)

(21) Appl. No.: 18/975,363

(22) Filed: Dec. 10, 2024

(30) Foreign Application Priority Data
Dec. 14, 2023 (JP) 2023-211400

(51) Int. Cl. F16C 19/36; F16C 33/46; F16C 33/58

(52) U.S. Cl. CPC F16C 19/364; F16C 33/46; F16C 33/585

(57) ABSTRACT

Provided is a tapered roller bearing which includes an inner ring including a collar part, an outer member having an annular rolling surface in opposition to a rolling surface of the inner ring, tapered rollers interposed between the inner ring and the outer member, and a retainer configured to be guided by the inner ring, retaining the tapered rollers, and including small- and large-diameter-side annular parts, and pillars connecting the small- and large-diameter-side annular parts at more than one circumferential location. At least one of the small-or large-diameter-side annular parts includes an arcuate bent part from the pillars and a flanged part extending radially inwards from the bent part. The bearing satisfies the inequalities 0.50018<(d₁/d₂)/2<0.5049; and 0.50018<(d₁/d₂)/2<0.5056X^{(-00.002)} involving the inner diameter of the flanged part d₁, the outer diameter of the collar part of the inner ring d₂, and the centrifugal acceleration of the revolution of the bearing X.

### CROSS REFERENCE TO THE RELATED APPLICATION

This application is based on and claims Convention priority to a Japanese patent application No. 2023-211400 filed Dec. 14, 2023, the entire disclosure of which is herein incorporated by reference as a part of this application.

### BACKGROUND OF THE INVENTION

### Field of the Invention

The present invention relates to a tapered roller bearing which can be applied to a component on which a centrifugal force acts, for example, in a planetary gear mechanism constituting a speed reducer in a construction machine and, more specifically, a planetary gear in a first stage where there is a significant centrifugal force.

### Description of Related Art

Common tapered roller bearings are of roller-guided type in which a retainer 5 is guided by tapered rollers 4, for example, as shown in FIG. 11. Yet, a bearing ring-guided (i.e., inner ring-guided or outer ring-guided) type is more preferred for tapered roller bearings used in environments involving revolving motion of components like planetary gears in a planetary speed reducer, since a retainer of a roller-guided type would exhibit poor behavior stability under centrifugal forces resulting from revolving motions and suffer from considerable wear of pillars.

In this connection, FIGS. 12A, 13A, 14A, and 15A depict how a tapered roller bearing operates with the use of a standard retainer of a roller-guided type, whereas FIGS. 12B, 13B, 14B, and 15B depict how a tapered roller bearing operates with the use of a retainer of an inner ring-guided type which is compatible with high centrifugal forces. Turning to FIGS. 13A and 13B illustrating a tapered roller bearing applied to planetary gears 105 of a planetary speed reducer, a centrifugal force F_{G} acts on the entirety of the tapered roller bearing as the tapered roller bearing undergoes a revolving motion as indicated with an arrow c. A centrifugal force F_{G} similarly acts on the entirety of a tapered roller bearing with a retainer of an outer ring-guided type which is compatible with high centrifugal forces, if it is applied to planetary gears.

To consider how the components of the tapered roller bearing interact with each other while the centrifugal force F_{G} resulting from the revolving motion is acting on the entirety of the bearing, it is assumed that an inner ring 2 of the tapered roller bearing is a stationary bearing ring and is therefore fixed in position. As illustrated in FIGS. 14A and 14B which show transverse cross sectional views of portions delimited by rectangles in FIGS. 13A and 13B, the centrifugal force F_{G} acts in such a way that pulls a retainer 5 in a direction away from the axis of the revolving motion. In the case of the roller-guided type shown in FIG. 14A, the retainer 5 is displaced considerably in the direction away from the axis of the revolving motion when pulled by the centrifugal force F_{G}, due to the large gap S that exists between the retainer 5 and inner ring collar parts, especially, a smaller collar part 2b. Turning to FIG. 15A which shows an enlarged lateral cross sectional view of the portion delimited by the rectangle in FIG. 13A, the clearance δ between a tapered roller 4 and the pocket inner surface of a pillar 8 of the retainer 5 is therefore closed, resulting in more wear of the pocket inner surface of the pillar 8.

In contrast, the gaps S₁, S₂ between the retainer 5 and the inner ring collar parts (i.e., a smaller collar part 2b and a larger collar part 2c) for an inner ring-guided type illustrated in FIG. 14B are small. Hence, the retainer 5 is displaced to a lesser degree in the direction away from the axis of the revolving motion when pulled by the centrifugal force. Turning to FIG. 15B which shows an enlarged lateral cross sectional view of the portion delimited by the rectangle in FIG. 13B, the clearance δ between a tapered roller 4 and the pocket inner surface of a pillar 8 is thus still present with no consequent increase of the wear of the pocket inner surface of the pillar 8.

Some tapered roller bearings of an inner ring-guided type include a retainer provided with a flanged part on both of the smaller diameter side and the larger diameter side thereof, so that the inner peripheral edge of each flanged part serves as a sliding surface by means of which the retainer is guided by an inner ring (for example, Chinese Laid-open Patent Publication No. 103410853.)

### SUMMARY OF THE INVENTION

Yet, a tapered roller bearing of an inner ring-guided type has the risk of reduction in the durability of a retainer 5 due to a stress caused by the axial cross section of the retainer 5 being deformed from a circular shape into an elliptical shape having a major axis along the direction of elongation, at the time of contact between the retainer 5 and an inner ring 2 at their sliding surfaces. The extent of deformation of the retainer 5 into the elliptical shape depends on the circumferential size of the region (or so-called guide region) where the sliding occurs between the retainer guiding surface of the inner ring 2 and the guided area of the retainer 5. That is, the smaller the circumferential size of the guide region is, the more concentrated the force resulting from the contact becomes in the circumferential direction, and the extent of deformation into the elliptical shape increases. The larger the circumferential size of the guide region is, the more dispersed the force becomes in the circumferential direction, and the extent of deformation into the elliptical shape decreases. The size of the guide region depends on the degree of spacing (or so-called guide gap) between the retainer guiding surface of the inner ring 2 and the guided area of the retainer 5. Thus, to increase the durability of the retainer 5 by lowering the stress caused by the elliptical deformation of the retainer, the relationship between the outer diameter of the retainer guiding surface of the inner ring 2 and the inner diameter of the guided area of the retainer 5 needs to be controlled appropriately. Further, the centrifugal force created by the revolving motion of the tapered roller bearing 1 can also be the cause of the sliding between the retainer guiding surface of the inner ring 2 and the guided area of the retainer 5. Therefore, the centrifugal acceleration of the tapered roller bearing 1 should also be taken into consideration.

An object of the present invention is to provide a tapered roller bearing of an inner ring-guided type which realizes an improved durability of a retainer by limiting deformation of the retainer in environments where the bearing makes a revolving motion with a centrifugal force acting on the retainer.

A tapered roller bearing 1 according to the present invention includes an inner ring 2 having a rolling surface 2a and including a collar part 2b, 2c, an outer member 3 having an annular rolling surface 3a in opposition to the rolling surface 2a of the inner ring 2, a plurality of tapered rollers 4 interposed between the inner ring 2 and the outer member 3, and a retainer 5 configured to be guided by the inner ring, retaining the plurality of tapered rollers 4, and including a small-diameter-side annular part 6, a large-diameter-side annular part 7, and pillars 8 connecting the small-diameter-side annular part 6 and the large-diameter-side annular part 7 at more than one circumferential location. At least one of the small-diameter-side annular part 6 or the large-diameter-side annular part 7 of the retainer 5 can include a flanged part 6a, 7a extending radially inwards via a bend from the pillars 8. The bearing 1 satisfies the conditions described by the following inequalities:

$$0.50018 < ( {d}_{1} / {d}_{2} ) / 2 < 0.5029 , and \qquad ( 1 )$$

$$0.50018 < ( {d}_{1} / {d}_{2} ) / 2 < 0.5056 {X}^{( - 0.002 )} , \qquad ( 2 )$$

where d₁ is the inner diameter of the flanged part 6a, 7a, d₂ is the outer diameter of the collar part 2b, 2c of the inner ring 2, and X is a centrifugal acceleration of the bearing which results from the revolving motion of the bearing and for which gravitational acceleration G is used as a unit.

According to this configuration, the centrifugal force of the tapered roller bearing 1 that acts on the retainer 5 can be circumferentially dispersed to suppress the deformation of the retainer 5. Thus, a stress that occurs in the retainer 5 is reduced. The resulting improved durability of the retainer 5 can prevent occurrence of failure of the same.

Inner ring guidance herein refers to the retainer 5 and the inner ring 2 having a dimension relationship where the radial gap between the inner diameter face of the retainer 5 and the outer circumferential surface of the inner ring 2 is so limited that the retainer 5 rotates with its inner diameter face having sliding contact with the outer circumferential surface of the inner ring 2.

For a tapered roller bearing according to the present invention, the retainer may comprise a press-formed or turned article.

For a tapered roller bearing 1 according to the present invention, the large-diameter-side annular part 7 may include an arcuate bent part from the pillars 8 and a flanged part 7a extending radially inwards from the bent part, and the flanged part 7a may form a bending angle relative to the pillars 8 in the range of 90±10 degrees, as measured by using, as a reference, an angle of the retainer defined by the pillars 8 extending oblique to the axis of the bearing.

The geometry of the retainer 5 becomes more suitable for inner ring-guided type when the bending angle of the flanged part 7a of the large-diameter-side annular part 7 is in the range of 90±10 degrees.

For a tapered roller bearing 1 according to the present invention, the large-diameter-side annular part 7 may include an arcuate bent part from the pillars 8 and a flanged part 7a extending radially inwards from the bent part, and the bent part 7b adjoining the flanged part 7a may have an inner diameter surface with a radius of curvature, which is more than 20% and less than 90% of the length of the large-diameter-side annular part 7 as measured in the direction of extension of the pillars 8.

When the radius of curvature is 20% or less of the axial length of the large-diameter-side annular part 7, there is a risk that stress concentration during a bending operation is so high that it would lead to failure of the retainer 5. On the other hand, when the radius of curvature is 90% or more of the axial length of the large-diameter-side annular part 7, there is a risk that the arcuate contour of the inner diameter surface of the bent part 7b becomes too shallow and could result in edge loading between an end face of the rollers 4 and an opening edge of pockets 9. These problems can be avoided by setting the radius of curvature to more than 20% and less than 90% of the axial length of the large-diameter-side annular part 7.

For a tapered roller bearing 1 according to the present invention, the flanged part 6a, 7a has an inner periphery which may include, at more than one circumferential location, a lubricant passage 10, 11 resembling a cutout or window and permitting a lubricant to pass through the flanged part 6a, 7a in the axial direction of the bearing.

A lubricant passage 10, 11 formed in such a manner facilitates the passage of a lubricant through the flanged part 6a, 7a of the retainer 5, resulting in better lubrication between the rolling surfaces of the tapered rollers 4 and the pocket inner surfaces of the retainer 5.

For a tapered roller bearing 1 according to the present invention, the ratio of the cross sectional area of the large-diameter-side annular part 7 to the cross sectional area of the small-diameter-side annular part 6 in the retainer 5 may be between 1.0 and 1.2.

When the ratio of the cross sectional area of the large-diameter-side annular part 7 to the cross sectional area of the small-diameter-side annular part 6 is in the range between 1.0 and 1.2, an appropriate weight balance between the larger diameter side and the smaller diameter side is achieved. Thus, whirling of the retainer 5 can be suppressed and better inner ring guidance can be carried out.

A tapered roller bearing 1 according to the present invention may be configured to be employed in and revolve integrally with a planetary gear of a planetary gear mechanism.

A tapered roller bearing according to the present invention satisfies the conditions described by the following inequalities:

$$0.50018 < ( {d}_{1} / {d}_{2} ) / 2 < 0.5049 , and \qquad ( 1 )$$

$$0.50018 < ( {d}_{1} / {d}_{2} ) / 2 < 0.5056 {X}^{( - 0.002 )} , \qquad ( 2 )$$

where d₁ is the inner diameter of the flanged part of the retainer, d₂ is the outer diameter of the collar part of the inner ring, and X is the centrifugal acceleration of the retainer and for which gravitational acceleration G is used as a unit. In this way, the gap between the collar part of the inner ring and the flanged part of the retainer becomes so small that the circumferential size of the region in which the collar part of the inner ring and the flanged part of the retainer contact increases, circumferentially dispersing the force that acts on the retainer during the contact. Thus, elliptical deformation appearing in the retainer can be suppressed, and a stress that occurs in the retainer can be reduced. Accordingly, improved durability and prevention of failure of the retainer can be achieved.

Any combinations of at least two features disclosed in the claims and/or the specification and/or the drawings should also be construed as encompassed by the present disclosure. Especially, any combinations of two or more of the claims should also be construed as encompassed by the present disclosure.

### BRIEF DESCRIPTION OF THE DRAWINGS

The present disclosure will be more clearly understood from the following description of preferred embodiments made with reference to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike or corresponding parts throughout the different figures, and:

FIG. 1 shows a cross sectional view of a tapered roller bearing in accordance with an embodiment of the present invention;

FIG. 2 shows a transverse cross sectional view of a retainer of the tapered roller bearing;

FIG. 3A shows an end view of a smaller diameter-side end of the retainer;

FIG. 3B shows an end view of a larger diameter-side end of the retainer;

FIG. 4 shows a fragmentally enlarged, transverse cross sectional view of the retainer;

FIG. 5 shows a fragmentally enlarged, transverse cross sectional view which illustrates a large-diameter-side annular part of the retainer and a tapered roller on a further enlarged scale;

FIG. 6 shows a diagram that illustrates how a centrifugal force acts on the tapered roller bearing when it is used in a planetary speed reducer;

FIG. 7 shows a plot that illustrates the results of dynamic analyses on the tapered roller bearing;

FIG. 8 shows a transverse cross sectional view of an example planetary speed reducer in which the tapered roller bearing is used;

FIG. 9 shows a cross sectional view taken along the line IX-IX in FIG. 8;

FIG. 10A shows a diagram that illustrates an example of a gauge used in gap control for the tapered roller bearing;

FIG. 10B shows a diagram that illustrates another example of a gauge used in gap control for the tapered roller bearing;

FIG. 11 shows a transverse cross sectional view of a conventional tapered roller bearing of a rolling element-guided type;

FIG. 12A shows a diagram that illustrates how a centrifugal force acts on a tapered roller bearing of a rolling element-guided type;

FIG. 12B shows a diagram that illustrates how a centrifugal force acts on a tapered roller bearing of an inner ring-guided type;

FIG. 13A shows another diagram that illustrates how a centrifugal force acts on a tapered roller bearing of a rolling element-guided type;

FIG. 13B shows another diagram that illustrates how a centrifugal force acts on a tapered roller bearing of an inner ring-guided type;

FIG. 14A shows yet another diagram that illustrates how a centrifugal force acts on a tapered roller bearing of a rolling element-guided type;

FIG. 14B shows yet another diagram that illustrates how a centrifugal force acts on a tapered roller bearing of an inner ring-guided type;

FIG. 15A shows yet another diagram that illustrates how a centrifugal force acts on a tapered roller bearing of a rolling element-guided type; and

FIG. 15B shows yet another diagram that illustrates how a centrifugal force acts on a tapered roller bearing of an inner ring-guided type.

### DESCRIPTION OF EMBODIMENTS

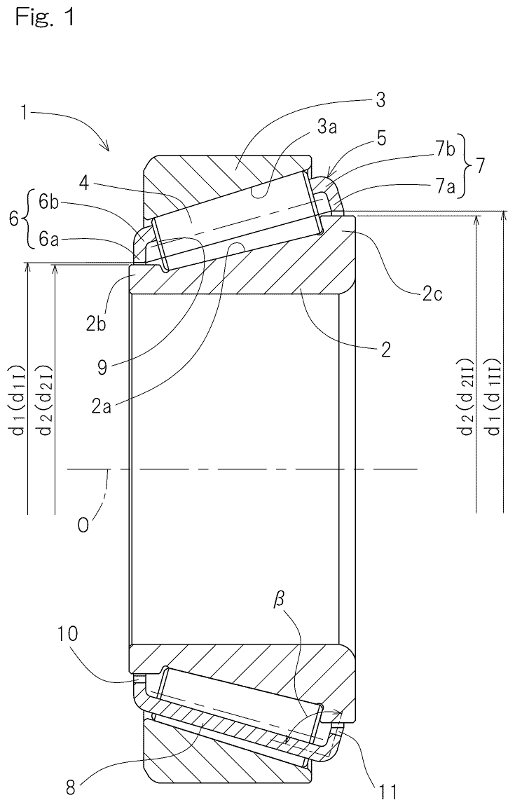

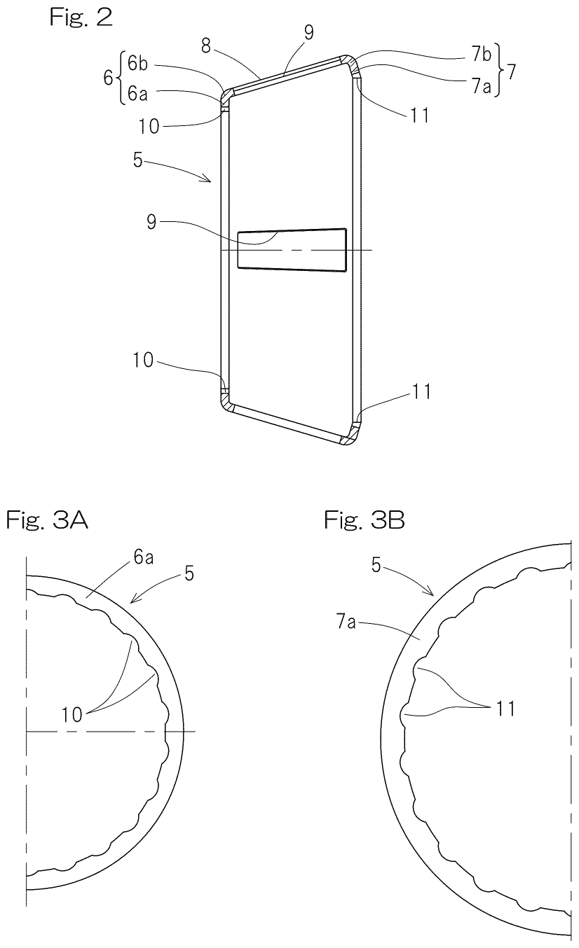

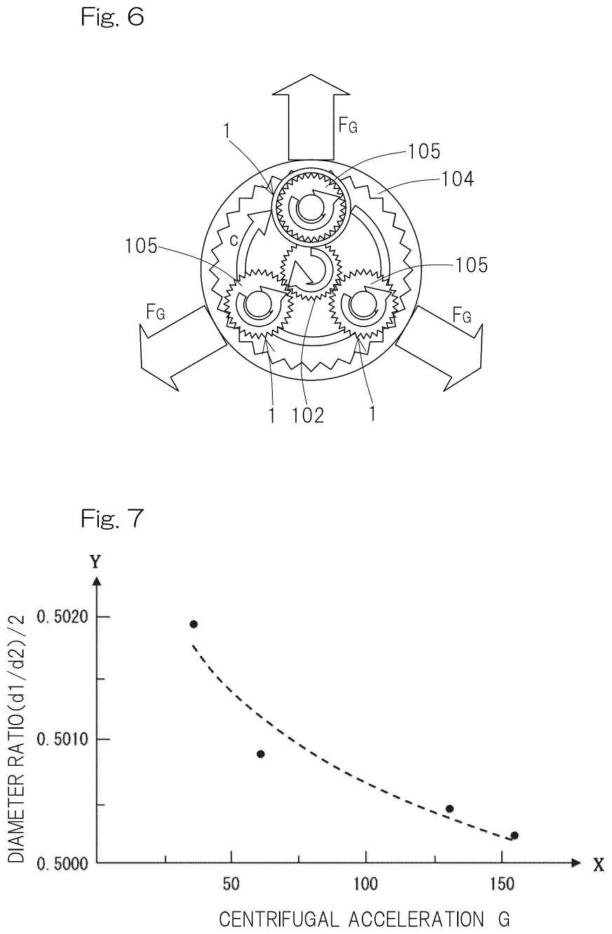

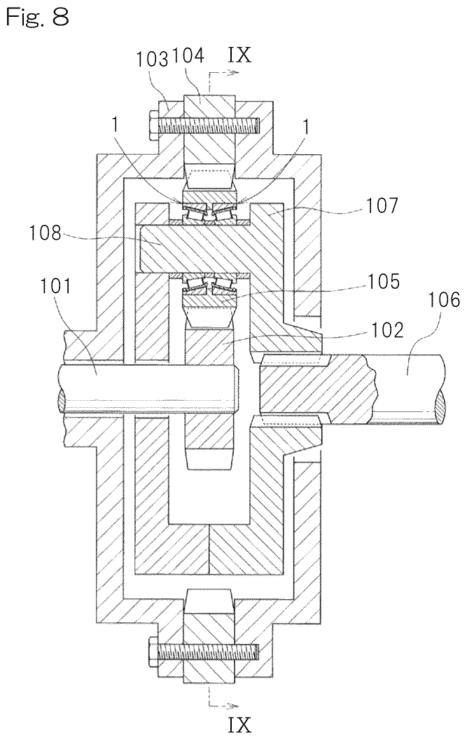

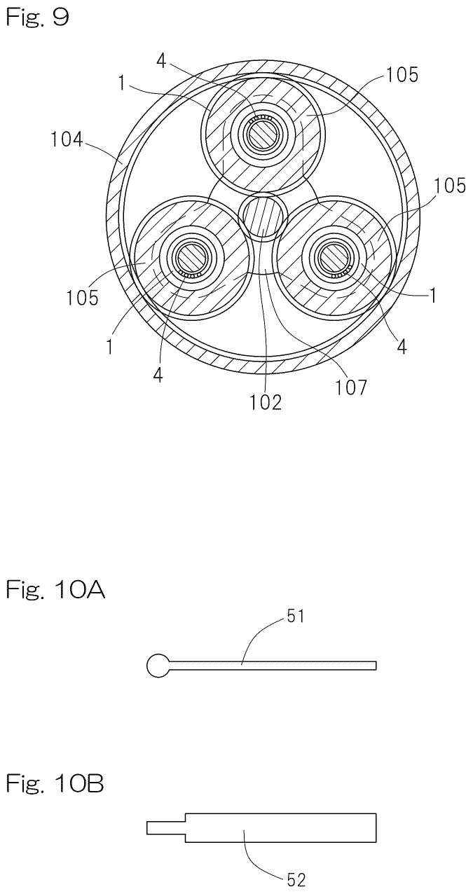

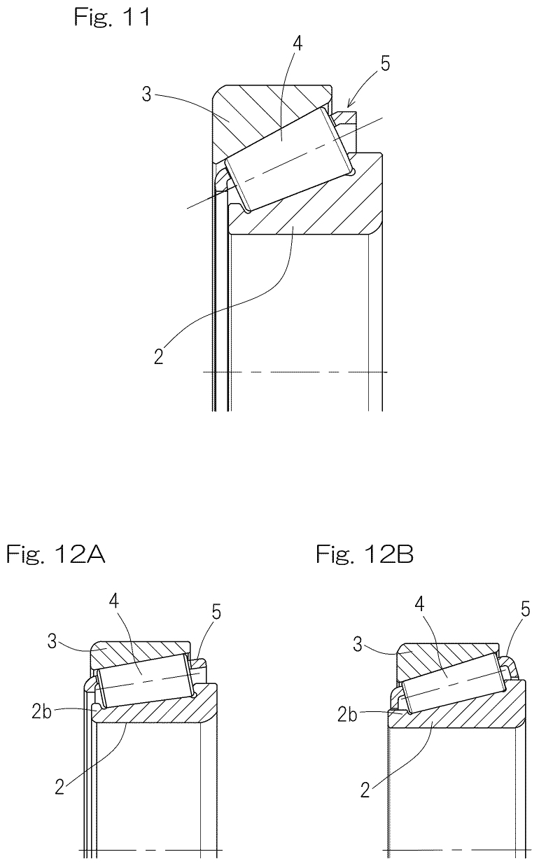

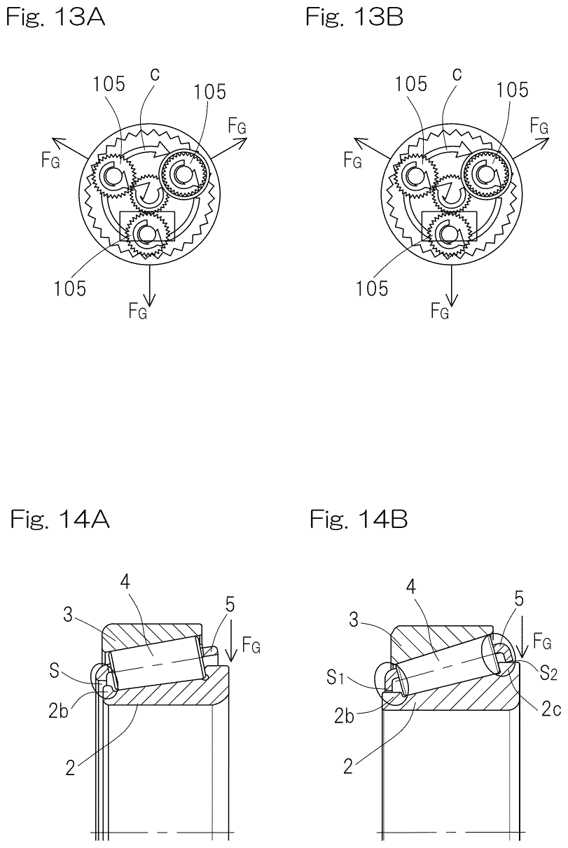

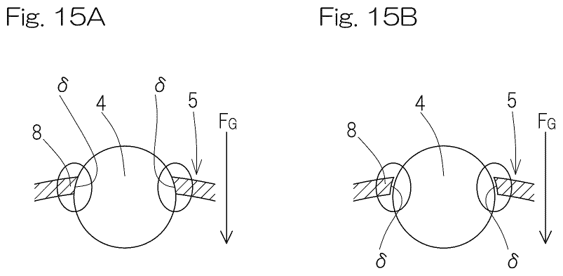

A tapered roller bearing in accordance with an embodiment of the present invention will be described below in connection with FIGS. 1 to 7. It should be noted that this tapered roller bearing 1 is intended to be employed in a planetary gear of a planetary speed reducer or planetary gear transmission which will be later discussed in connection with FIGS. 8 and 9.

Turning to FIG. 1, the tapered roller bearing 1 includes an inner ring 2, an outer member 3, a plurality of tapered rollers 4 interposed between the inner ring 2 and the outer member 3, and a retainer 5 retaining the plurality of tapered rollers 4. The inner ring 2 has a tapered rolling surface 2a with an increasing diameter from a point at one end to a point at the other end of the outer circumferential surface of the inner ring 2 in the axial direction of the bearing (which is a direction along the axis O of the bearing and may also be referred to as “axial direction” in short), and has respective collar parts 2b, 2c on the one end and the other end thereof. The outer member 3 is in the form of an annular component having a tapered rolling surface 3a with an increasing diameter from one end to the other end of the outer member 3 in opposition to the rolling surface 2a of the inner ring 2. Although the outer member 3 corresponds to an “outer ring” when it plays no other role than that of a bearing component, the concept of the “outer member” used herein encompasses, for example, components with an outer circumferential side that forms a geared section and an inner circumferential side that has a rolling surface 3a. It should be noted that the term “outer ring” herein is often substituted for the term “outer member” in examples concerning testing and analysis, etc. While the inner ring 2 is shown with collar parts on both sides in the illustrated embodiment, it may alternatively include a collar part on only one of the one end or the other end thereof. Further, while the outer member 3 is shown with no collar parts in the illustrated embodiment, it may include a collar part (not shown) protruding radially inwards from either one of the one end or the other end thereof.

The retainer 5 includes a small-diameter-side annular part 6, a large-diameter-side annular part 7, and pillars 8 connecting the small-diameter-side annular part 6 and the large-diameter-side annular part 7 at more than one circumferential location. The adjacent pillars 8 define, therebetween, pockets 9 in which the tapered rollers 4 are retained. The inner diameter faces of the small-diameter-side annular part 6 and the large-diameter-side annular part 7 of the retainer 5 have such a diameter that the respective inner diameter faces are guided by the two collar parts 2b, 2c of the inner ring 2. Thus, the tapered roller bearing 1 is that of an inner ring-guided type. In the discussions that follow, one of the collar parts 2b by which the small-diameter-side annular part 6 of the retainer 5 is guided is referred to as a smaller collar part, while the other collar part 2c by which the large-diameter-side annular part 7 is guided is referred to as a larger collar part. It should be noted that the retainer 5 can be any retainer of inner ring-guided type, including that which is guided by only one of the smaller collar part 2b or the larger collar part 2c of the inner ring 2. It is generally preferred for the retainer 5 to be at least guided by the smaller collar part 2b of the inner ring 2.

The tapered roller bearing 1 is configured to be employed in a planetary gear of a planetary gear mechanism for a planetary speed reducer, planetary gear transmission, or the like, in an apparatus including the planetary gear mechanism, to rotatably support the rotation of the planetary gear on its own axis and revolve integrally with the planetary gear. Therefore, the tapered roller bearing 1 exhibits a centrifugal acceleration. The dimensions of the tapered roller bearing 1 are defined so as to satisfy the conditions described by the following inequalities:

$$0.50018 < ( {d}_{1} / {d}_{2} ) / 2 < 0.5049 , and \qquad ( 1 )$$

$$0.50018 < ( {d}_{1} / {d}_{2} ) / 2 < 0.5056 {X}^{( - 0.002 )} , \qquad ( 2 )$$

where d₁ is the inner diameter of a flanged part of the retainer 5 of the tapered roller bearing 1, d₂ is the outer diameter of a collar part of the inner ring 2, and X is expressed as a dimensionless number of the centrifugal acceleration of the tapered roller bearing 1 which results from a revolving motion of the same during its rated operation when incorporated into the apparatus including the planetary gear mechanism and for which gravitational acceleration G is used as a unit. The centrifugal acceleration X represents an acceleration of the tapered roller bearing when it is undergoing a circular motion or other accelerated motions along a curve. A tapered roller bearing making a revolving motion as in the instant embodiment is considered to be in a circular motion. Therefore, its centrifugal acceleration can be calculated from the revolving radius r and the revolving angular velocity ω of the revolving motion, according to the formula:

$$( centrifugal acceleration X ) = ( revolving radius r ) \times {( revolving angular velocity ω )}^{2} .$$

In this context, when the small-diameter-side annular part 6 of the retainer 5 includes a flanged part 6a and the inner ring 2 includes the smaller collar part 2b on the smaller diameter side thereof, the inner diameter d_{1I} of the flanged part 6a and the outer diameter d_{2I} of the smaller collar part 2b are respectively treated as d₁, d₂. When the large-diameter-side annular part 7 of the retainer 5 includes a flanged part 7a and the inner ring 2 includes the larger collar part 2c on the larger diameter side thereof, the inner diameter d_{1II} of the flanged part 7a and the outer diameter d_{2II} of the larger collar part 2c are respectively treated as d₁, d₂. When the inner ring 2 includes collar parts on both sides, namely, the smaller collar part 2b and the large collar part 2c, and the retainer includes flanged parts 6a, 7a on both of the small-diameter-side annular part 6 and the large-diameter-side annular part 7 as in FIG. 1, the sets of the inner diameter dii, dill of a flanged part and the outer diameter d_{2I}, d_{2II} of a collar part on the smaller diameter side and the larger diameter side are both arranged to satisfy the ranges described by inequalities (1) and (2). The subscript “I” denotes association with the smaller diameter side, while the subscript “II” denotes association with the larger diameter side.

The value of 0.50018 in inequalities (1) and (2) is chosen so that more than a zero guide gap is left during expansion of the inner ring 2. The value of 0.5049 in inequality (1) is chosen based on the upper limit of the guide gap range in which inner ring guidance can be ensured for the tapered roller bearing. The term 0.5056X^{(-00.002)} in inequality (2) is selected on the basis of the results of dynamic analyses conducted using conditions which simulated a planetary gear mechanism of a planetary speed reducer with parameters including the inner diameter d₁ of a flanged part of a retainer, the outer diameter d₂ of a collar part of an inner ring, and a centrifugal acceleration X.

FIG. 7 shows a plot that illustrates the results of the dynamic analyses. The horizontal X-axis of the plot represents the centrifugal acceleration of a tapered roller bearing 1 during its revolving motion with gravitational acceleration G used as a unit therefor, and the vertical Y-axis of the plot represents (d₁/d₂)/2 which is obtained by dividing by two the diameter ratio between the inner diameter d₁ of a retainer and the outer diameter d₂ of an inner ring. The points plotted in the plot indicate centrifugal accelerations X and values of (d₁/d₂)/2 at which tapered roller bearings revolving in a planetary gear mechanism reached a prescribed threshold of a stress that occurs in a retainer pertaining to failure appearing in the retainer. These plotted points could be approximated with a broken line in the plot which is described by the formula: Y=0.5056X^{(-00.002)}. The formula has been shown to indicate the upper values of (d₁/d₂)/2 below which the stress appearing in a retainer is so small that occurrence of failure in the retainer can be prevented.

Thus, in regard to the inner diameter d₁ of a retainer and the outer diameter d₂ of an inner ring, the value of (d₁/d₂)/2 is set so as to be in the range: 0.50018<(d₁/d₂)/2<0.5049; and 0.50018<(d₁/d₂)/2<0.5056X^{(-00.002)}. In this manner, the inner ring d₁ of a flanged part of a retainer and the outer diameter d₂ of a collar part of an inner ring can be selected appropriately in consideration of deformation of the retainer caused by the centrifugal acceleration X of a tapered roller bearing, expansion of the inner ring, etc. Thus, elliptical deformation appearing in the retainer can be suppressed, and a stress that occurs in the retainer can be reduced. Accordingly, improved durability and prevention of failure of the retainer can be achieved.

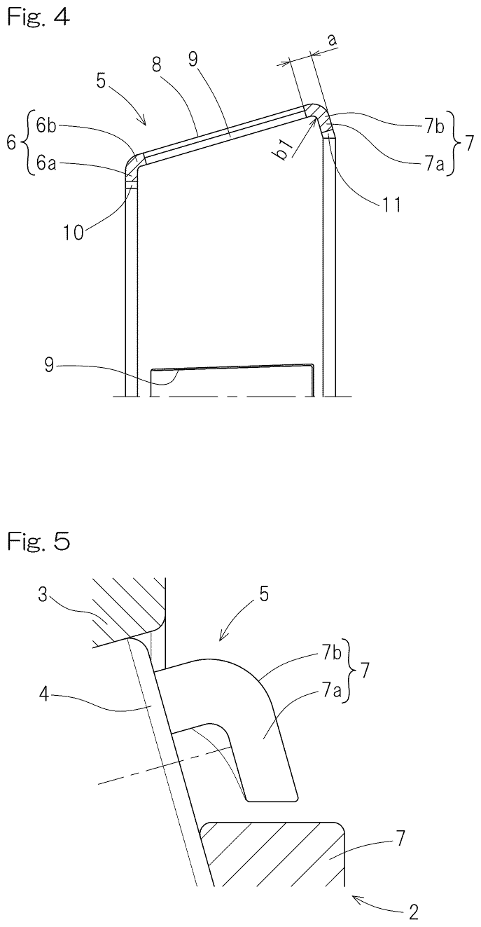

Further, referring to FIG. 4, the small-diameter-side annular part 6 and the large-diameter-side annular part 7 of the retainer 5 of the tapered roller bearing include arcuate corner sections 6b, 7b from the pillars 8 and flanged parts 6a, 7a extending radially inwards from the bent parts 6b, 7b. The retainer 5 in the instant embodiment comprises an article press-formed from a metal sheet like an iron metal sheet, while the retainer 5 may alternatively be molded from plastic. The small-diameter-side annular part 6 and the large-diameter-side annular part 7 are formed by a bending operation. The pillars 8 are formed by punching off material during the press forming operation to create the pockets 9. The retainer 5 may alternatively be made by a turning operation from metal or may comprise a plastic molded article.

Also, in the tapered roller bearing 1, the flanged part 7a of the large-diameter-side annular part 7 forms a bending angle β relative to the pillars 8 in the range of 90±10 degrees (i.e., between 80 degrees and 100 degrees, inclusive), as measured by using, as a reference, an angle of the retainer defined by the pillars 8 extending oblique to the axis O of the bearing. The geometry of the retainer 5 becomes more suitable for inner ring-guided type when the bending angle β of the flanged part 7a is in the range of 90±10 degrees. The inner diameter faces of the small-diameter-side annular part 6 and the large-diameter-side annular part 7 preferably extend parallel to the outer peripheral surfaces of the smaller collar part 2b and the larger collar part 2c of the inner ring 2, respectively, while they may alternatively extend at an angle to the latter.

Further, referring again to FIG. 4, in the tapered roller bearing 1, the bent part 7b adjoining the flanged part 7a of the large-diameter-side annular part 7 has an inner diameter surface with a radius b1 of curvature, which is more than 20% and less than 90% of the length a of the large-diameter-side annular part 7 as measured in the direction of extension of the pillars 8. When the radius b1 of curvature of the inner diameter surface of the bent part 7b of the large-diameter-side annular part 7 is 20% or less of the length a of the large-diameter-side annular part 7 as measured in the direction of extension of the pillars 8, there is a risk that stress concentration during the bending operation of the retainer 5 is so high that it would lead to failure of the same. When the radius b1 of curvature is 90% or more of the length a of the large-diameter-side annular part 7, there is a risk that the arcuate contour of the inner diameter surface of the bent part 7b becomes too shallow, as indicated with the thin line in FIG. 5, and could result in edge loading between an end face of the tapered rollers 4 and an opening edge of the pockets 9. These problems can be avoided by setting the radius b1 of curvature to more than 20% and less than 90% of the length a of the large-diameter-side annular part 7.

Further, referring to FIGS. 3A and 3B, in the tapered roller bearing 1, the flanged parts 6a, 7a have an inner periphery which includes, at more than one location, a lubricant passage 10, 11 resembling a cutout and permitting a lubricant oil to pass through the flanged parts 6a, 7a in the axial direction of the bearing. While the cutout of the lubricant passage 10, 11 in the instant embodiment has an arcuate shape, it may alternatively have an elliptically arcuate shape or any other shape. Still alternatively, only one of the small-diameter-side annular part 6 or the large-diameter-side annular part 7 may include a flanged part. A lubricant passage 10, 11 provided in such a manner facilitates the passage of a lubricant through the flanged parts 6a, 7a of the retainer 5, resulting in better lubrication between the tapered rollers 4 and the rolling surfaces 2a, 3a and between the tapered rollers 4 and the pocket inner surfaces of the retainer. Nevertheless, the lubricant passage 10, 11 is optional.

Further, in the tapered roller bearing 1, the ratio of the cross sectional area of the large-diameter-side annular part 7, as measured in a transverse cross section that does not contain the lubricant passage 11, to the cross sectional area of the small-diameter-side annular part 6, as measured in a transverse cross section that does not contain the lubricant passage 10, may be more than 1.0 and less than 1.2, as is shown on the upper side of FIG. 1. When this ratio of cross sectional area is more than 1.0 and less than 1.2, an appropriate weight balance between the larger diameter side and the smaller diameter side is achieved. Thus, whirling of the retainer 5 can be suppressed and better inner ring guidance can be carried out. It should be noted that the cross sectional area of the small-diameter-side annular part 6, as measured in a transverse cross section that does not contain the lubricant passage 10, represents the maximum value of the transverse cross sectional area of the small-diameter-side annular part 6, while the cross sectional area of the large-diameter-side annular part 7, as measured in a transverse cross section that does not contain the lubricant passage 11, represents the maximum value of the transverse cross sectional area of the large-diameter-side annular part 7.

FIGS. 8 and 9 depict an example planetary speed reducer in which the tapered roller bearing 1 of the instant embodiment is used. The planetary speed reducer includes a planetary gear mechanism. That is, a plurality of planetary gears 105 are arranged between a sun gear 102 mounted on an input shaft 101 and an internal gear 104 secured to a housing 103 so as to meshingly engage with both gears 102, 104. Each of the planetary gears 105 is rotatably supported on a carrier 107 that is coupled to an output shaft 106. The revolving motion that the planetary gears 105 undergo while rotating on their own axes between the sun gear 102 and the internal gear 104 is transmitted through the carrier 107 to the output shaft 106. For example, the planetary speed reducer is responsible for the first-stage speed reduction of a final speed reduction device which is located inside a wheel rim of a construction machine.

A pair of the tapered roller bearings 1 are disposed between the carrier 107 and each of the planetary gears 105 of the planetary speed reducer. The outer member 3 (FIG. 1) of each of the tapered roller bearings 1 is fitted to a corresponding of the planetary gears 105 to rotate as a unit with the same. The inner ring 2 of each of the tapered roller bearings 1 is fitted fixedly to a corresponding one of support shafts 108 located on the carrier 107.

It should be noted that the smaller diameter-side gap S₁ between the small-diameter-side annular part 6 and the smaller collar part 2b of the inner ring 2 and the larger diameter-side gap S₂ between the large-diameter-side annular part 7 and the larger collar part 2c of the inner ring 2 in FIGS. 1 and 14B should be measured as appropriate to check whether they are within appropriate ranges, because, for example, inadequate crimping of the small-diameter-side annular part 6 of the retainer 5 during assembly can cause them to deviate. For instance, as a preparation for appropriate measurement of the smaller diameter-side gap S₁, firstly, a reference feeler gauge 51 illustrated in FIG. 10A is inserted to position its tip ball section (e.g., with a prescribed diameter set to the design value of S₁) between the smaller collar part 2b of the inner ring 2 and the small-diameter-side annular part 6 of the retainer 5 at an arbitrarily chosen circumferential point (which is considered as a 0 degree angular position). Then, the smaller diameter-side gap S₁ is measured at a 180 degree angular position that is radially opposite to the 0 degree angular position by using one of measurement feeler gauges 52 (i.e., one from a plurality of gauges having a tip cylindrical section with slightly different diameters) shown in FIG. 10B. The same procedure is performed again by switching the angular position where the reference feeler gauge 51 is inserted and the angular position where the measurement feeler gauges 52 are used. The values of the smaller diameter-side gap S₁ obtained from both measurements are averaged to obtain a reference gap.

For the actual appropriate measurement, the reference feeler gauge 51 is inserted to position the its tip ball section between the smaller collar part 2b of the inner ring 2 and the small-diameter-side annular part 6 of the retainer 5 at an arbitrarily chosen circumferential point (which is considered as a 0 degree angular position) so that the reference gap is created at a 180 degree angular position therefrom. Then, the smaller diameter-side gap S₁ at the 180 degree angular position is measured by using the measurement feeler gauges 52 to check whether this smaller diameter-side gap S₁ is within a predetermined tolerance from the reference gap. The larger diameter-side gap S₂ can also be checked by similar appropriate measurements to see whether it is within a tolerance.

While features for implementing the present invention have been described thus far on the basis of embodiments, the embodiments disclosed herein should be considered in all respects as illustrative and not restrictive. The scope of the present invention is defined not by the foregoing description, but by the appended claims, and is meant to encompass all the possible changes that do not depart from the scope of the appended claims and that would come within the meaning of equivalency thereof.
1 . . . tapered roller bearing
2 . . . inner ring
2a . . . rolling surface
2b, 2c . . . collar part
3 . . . outer member
3a . . . rolling surface
4 . . . tapered roller
5 . . . retainer
6 . . . small-diameter-side annular part
6a . . . flanged part
7 . . . large-diameter-side annular part
7a . . . flanged part
7b . . . bent part
8 . . . pillar
9 . . . pocket
10, 11 . . . oil passage
b1 . . . curvature radius of inner diameter surface of bent part
d_{1I} . . . inner diameter of flanged part of small-diameter-side annular part
d_{1II} . . . inner diameter of flanged part of large-diameter-side annular part
d_{2I} . . . outer diameter of smaller collar part of inner ring
d_{2II} . . . outer diameter of larger collar part of inner ring
O . . . bearing axis
β . . . bending angle

What is claimed is:

1. A tapered roller bearing comprising:
an inner ring including a collar part;
an outer member including a rolling surface having an annular shape, the rolling surface facing a rolling surface of the inner ring;
a plurality of tapered rollers interposed between the inner ring and the outer member; and
a retainer configured to retaining the plurality of tapered rollers, the retainer being guided by the inner ring, and including a small-diameter-side annular part, a large-diameter-side annular part, and pillars connecting the small-diameter-side annular part and the large-diameter-side annular part at more than one circumferential location, at least one of the small-diameter-side annular part or the large-diameter-side annular part including an arcuate bent part from the pillars and a flanged part extending radially inwards from the bent part,
the bearing rotating in a revolving motion, and satisfying conditions described by the following inequalities:
$$0.50018 < ( {d}_{1} / {d}_{2} ) / 2 < 0.5049 , and \qquad ( 1 )$$
$$0.50018 < ( {d}_{1} / {d}_{2} ) / 2 < 0.5056 {X}^{( - 0.002 )} , \qquad ( 2 )$$
where d₁ is an inner diameter of the flanged part, d₂ is an outer diameter of the collar part, and X is a centrifugal acceleration of the bearing which results from the revolving motion of the bearing, and is a valued expressed in units of gravitational acceleration G.

2. The tapered roller bearing as claimed in claim 1, wherein the retainer comprises a press-formed or turned article.

3. The tapered roller bearing as claimed in claim 1, wherein the large-diameter-side annular part includes an arcuate bent part from the pillars and a flanged part extending radially inwards from the bent part, and the flanged part forms a bending angle relative to the pillars in the range of 90±10 degrees, as measured by using, as a reference, an angle of the retainer defined by the pillars extending oblique to an axis of the bearing.

4. The tapered roller bearing as claimed in claim 1, wherein the large-diameter-side annular part includes an arcuate bent part from the pillars and a flanged part extending radially inwards from the bent part, and the bent part adjoining the flanged part has an inner diameter surface with a radius of curvature, which is more than 20% and less than 90% of a length of the large-diameter-side annular part as measured in a direction of extension of the pillars.

5. The tapered roller bearing as claimed in claim 1, wherein the flanged part has an inner periphery which is provided, at more than one location, with oil passages in the form of cutouts which permit passage of lubricating oil inward and outward of the flanged part in an axial direction of the bearing.

6. The tapered roller bearing as claimed in claim 1, wherein a ratio of a cross section area of the large-diameter-side annular part to a cross section area of the small-diameter-side annular part, as measured in a transverse cross section, is more than 1.0 and less than 1.2.

7. The tapered roller bearing as claimed in claim 1, wherein the tapered roller bearing is configured to be employed in and revolve integrally with a planetary gear of a planetary gear mechanism.
